(19) United States
(12) Patent Application Publication
(10) Pub. No.: US 2026/0085804 A1
(43) Pub. Date: Mar. 26, 2026

(54) LAMP FOR VEHICLE

(71) Applicant: HYUNDAI MOBIS CO., LTD., Seoul (KR)

(72) Inventors: Seok Ho JEONG, Yongin-si (KR); Jun Seok BAE, Yongin-si (KR); Eun Bi KWON, Yongin-si (KR)

(73) Assignee: HYUNDAI MOBIS CO., LTD., Seoul (KR)

(21) Appl. No.: 19/243,930

(22) Filed: Jun. 20, 2025

(30) Foreign Application Priority Data
Sep. 25, 2024 (KR) 10-2024-0130143

(51) Int. Cl. F21S 41/275; F21S 41/29

(52) U.S. Cl. CPC F21S 41/275; F21S 41/295

(57) ABSTRACT

The present disclosure provides a lamp for a vehicle, the lamp including a light-entering part installed relatively forward based on a propagation direction of light emitted from a light source installed in the lamp for a vehicle, the light-entering part being configured to receive the light emitted from the light source and having a plurality of patterns formed on an incident surface, and a light-exiting part configured to allow the light having passed through the light-entering part to propagate forward to the outside while passing through the light-exiting part, the light-exiting part having a plurality of facets formed on an emergent surface.

### CROSS-REFERENCE TO RELATED APPLICATIONS

This application claims priority to and the benefit of Korean Patent Application No. 10-2024-0130143 filed in the Korean Intellectual Property Office on Sep. 25, 2024, the entire contents of which are incorporated herein by reference.

### TECHNICAL FIELD

The present disclosure relates to a lamp for a vehicle, and more particularly, to a lamp for a vehicle, in which a plurality of patterns are formed on an incident surface of a light-entering part formed on a lens installed in the lamp for a vehicle to improve uniformity of light emitted through a light-exiting part, and light transmittance of light emitted from an edge of an emergent surface formed on the light-exiting part is adjusted to efficiently and precisely reduce glare.

### BACKGROUND

A vehicle is equipped with headlamps to travel at night.

The headlamp is intended to illuminate a route for the vehicle by emitting light forward at night. The headlamp is disposed to illuminate a location spaced apart forward from the vehicle by about 100 m.

The distance and range of light emitted from the headlamp varies from country to country depending on the predetermined standards.

In the related art, the headlamps are generally manufactured in four ways.

In one way, light emitted from a light source passes through an aspherical lens and then is reflected by a reflective surface to compensate for light lost from the light source, thereby improving luminous efficiency.

In another way, light emitted from a light source is reflected by an elliptical reflective surface, a part of the light propagates toward a focal point at which a shield is present, and the remaining light is blocked, such that the light propagates back toward a location in front of the vehicle through a projection lens.

In still another way, light emitted from a light source is reflected by a reflective surface having a parabolic surface and propagates toward a location in front of the vehicle. Lastly, in yet another way, light emitted from a light source passes through an aspherical lens and propagates toward a location in front of the vehicle.

Regarding the structure that emits light toward a location in front of the vehicle through an aspherical lens having a smooth shape among the structures of the headlamps in the related art, there is a need for studies related to a technology capable of reducing a loss of light, improving uniformity of light, reducing glare caused by the lamp for a vehicle, and improving performance of an optical system.

### SUMMARY

The present disclosure has been made in an effort to provide a lamp for a vehicle, in which a plurality of patterns are formed on an incident surface of a light-entering part formed on a lens installed in the lamp for a vehicle to improve uniformity of light emitted through a light-exiting part, and light transmittance of light emitted from an edge of an emergent surface formed on the light-exiting part is adjusted to efficiently and precisely reduce glare.

In order to achieve the above-mentioned object, the present disclosure provides a lamp for a vehicle, the lamp including: a light-entering part installed relatively forward based on a propagation direction of light emitted from a light source installed in the lamp for a vehicle, the light-entering part being configured to receive the light emitted from the light source and having a plurality of patterns formed on an incident surface; and a light-exiting part configured to allow the light having passed through the light-entering part to propagate forward to the outside while passing through the light-exiting part, the light-exiting part having a plurality of facets formed on an emergent surface.

In this case, the plurality of patterns formed on the incident surface may be configured as lattice patterns formed in a height direction and a width direction of the light-entering part.

Further, the lattice patterns may be arranged at intersection positions without overlapping the facets formed on the emergent surface in the propagation direction of the light.

In addition, the plurality of patterns formed on the incident surface may be configured as diagonal patterns formed in a diagonal direction of the light-entering part.

Further, the diagonal pattern may be formed to be curved inward.

Further, the plurality of patterns formed on the incident surface may be formed as circular or elliptical patterns.

In addition, the plurality of patterns formed on the incident surface may be formed as triangular patterns.

Further, the plurality of patterns formed on the incident surface may be formed as hexagonal patterns.

Further, the plurality of patterns formed on the incident surface may be formed as octagonal patterns.

In addition, a plate surface of the incident surface on which the pattern is formed may be formed to be curved.

Further, stepped portions recessed inward in the propagation direction of the light may be disposed at a plurality of points on the light-entering part and spaced apart from one another at predetermined intervals in a width direction of the light-entering part.

Further, a light transmittance-reducing member configured to reduce light transmittance may be provided in an edge region of a part of the facet provided on the emergent surface of the light-exiting part.

In addition, the light transmittance-reducing member may be configured as an edge portion pad printed in the edge region of at least a part of the facet.

Further, the lamp may further include a connection member provided between the light-entering part and the light-exiting part so that the light-entering part and the light-exiting part are connected to each other by being fixed to plate surfaces of the connection member disposed in opposite directions.

In order to achieve the above-mentioned object, a periphery of the connection member may be formed to be relatively larger than a periphery of the light-entering part and a periphery of the light-exiting part and protrude outward, and the lamp may further include a separate lens holder on which the protruding periphery of the connection member is seated and assembled.

According to the lamp for a vehicle according to the present disclosure as described above, the plurality of patterns may be formed on the incident surface of the light-entering part formed on the lens installed in the lamp for a vehicle to improve the uniformity of light emitted through the light-exiting part, and the light transmittance of light emitted from the edge of the emergent surface formed on the light-exiting part may be adjusted to efficiently and precisely reduce glare.

### BRIEF DESCRIPTION OF THE DRAWINGS

FIG. 1 is a perspective view illustrating a structure of a lamp for a vehicle according to the present disclosure.

FIG. 2 is a perspective view illustrating a structure of a light-entering part according to a first embodiment of the lamp for a vehicle according to the present disclosure.

FIG. 3 is a top plan view illustrating a structure in which facets formed on an emergent surface and patterns formed on an incident surface of the lamp for a vehicle according to the present disclosure, are disposed.

FIG. 4 is a perspective view illustrating a structure of a light-entering part according to a second embodiment of the lamp for a vehicle according to the present disclosure.

FIG. 5 is a perspective view illustrating a structure of a light-entering part according to a third embodiment of the lamp for a vehicle according to the present disclosure.

FIG. 6 is a perspective view illustrating a structure of a light-entering part according to a fourth embodiment of the lamp for a vehicle according to the present disclosure.

FIG. 7 is a perspective view illustrating a structure of a light-entering part according to a fifth embodiment of the lamp for a vehicle according to the present disclosure.

FIG. 8 is a perspective view illustrating a structure of a light-entering part according to a sixth embodiment of the lamp for a vehicle according to the present disclosure.

FIG. 9 is a perspective view illustrating a structure of a light-entering part according to a seventh embodiment of the lamp for a vehicle according to the present disclosure.

FIG. 10 is a perspective view illustrating structures of facets formed on the emergent surface of the lamp for a vehicle according to the present disclosure.

FIG. 11 is an exploded perspective view illustrating a disassembled structure of the lamp for a vehicle according to the present disclosure.

### DETAILED DESCRIPTION

Hereinafter, a lamp for a vehicle according to an embodiment of the present disclosure will be described in more detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected,’ ‘coupled,’ or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

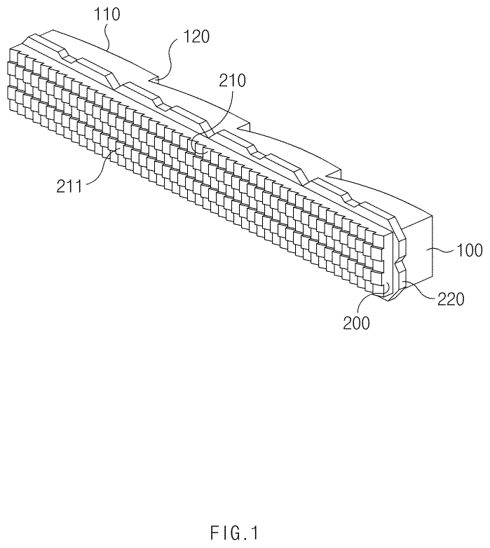

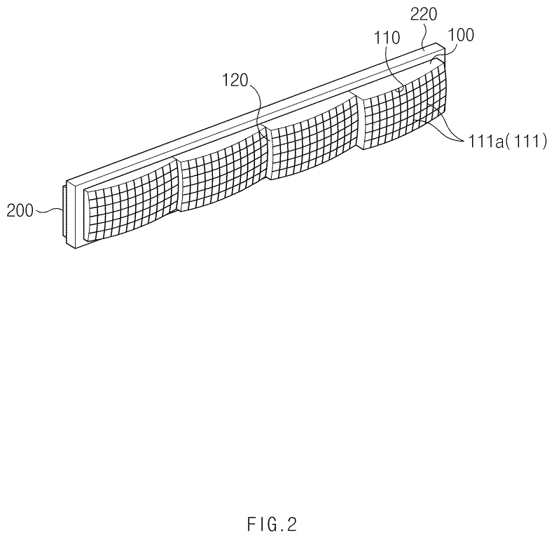

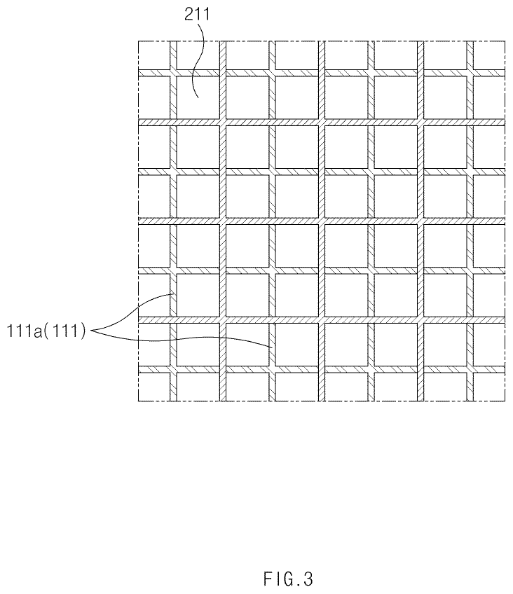

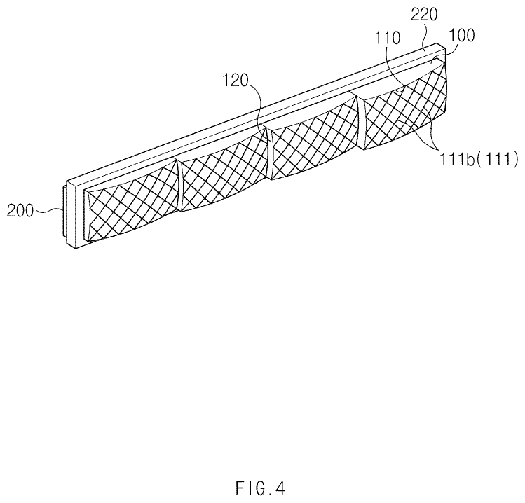

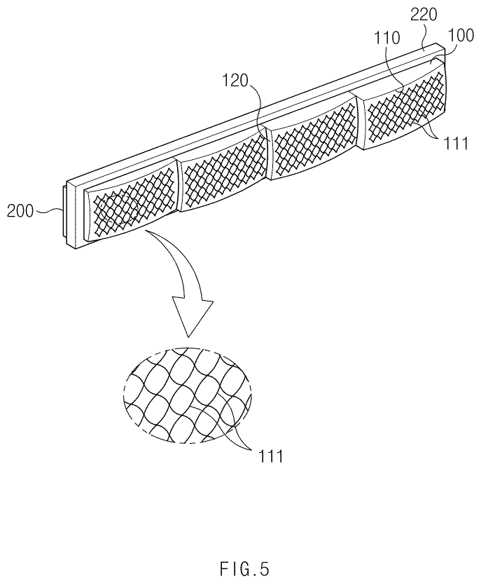

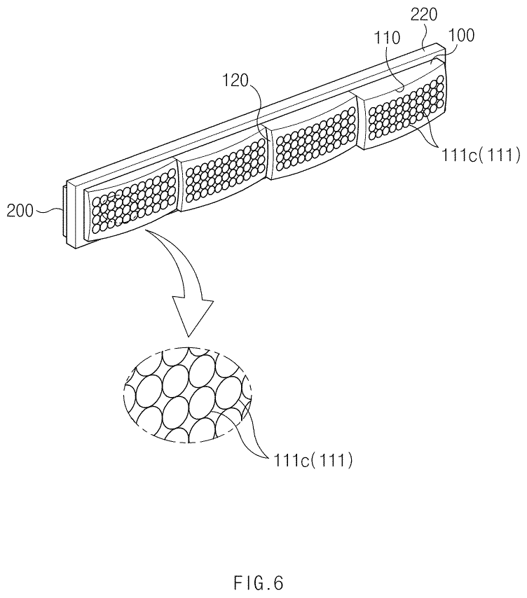

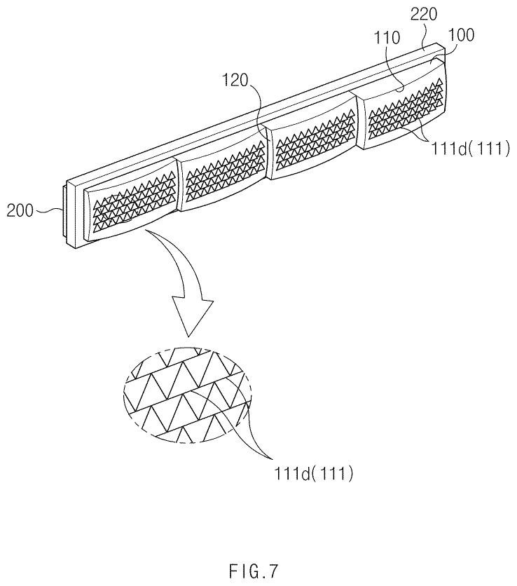

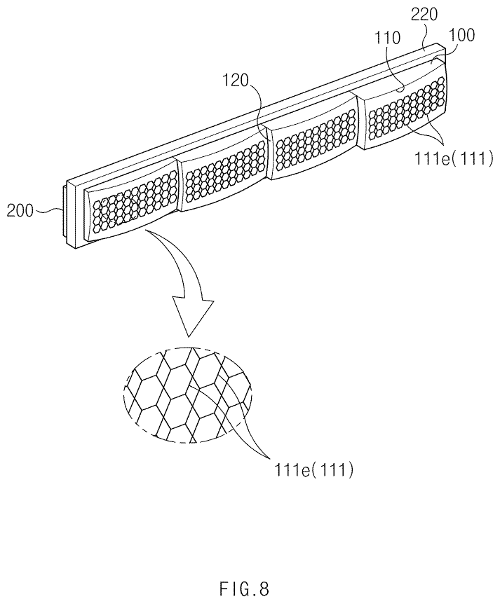

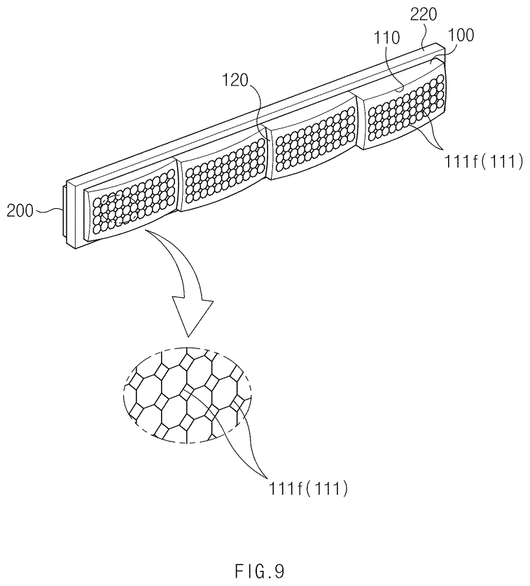

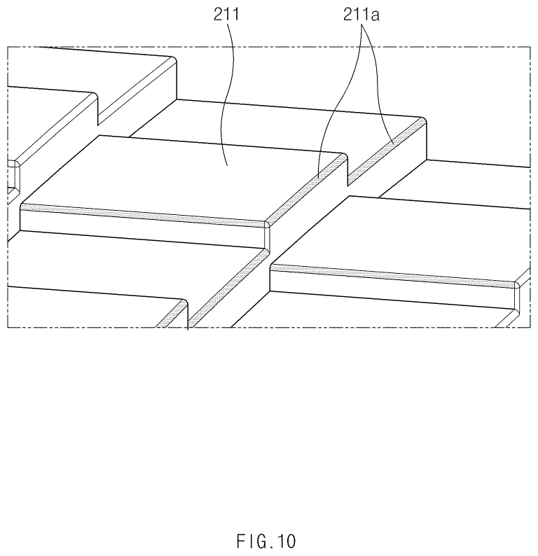

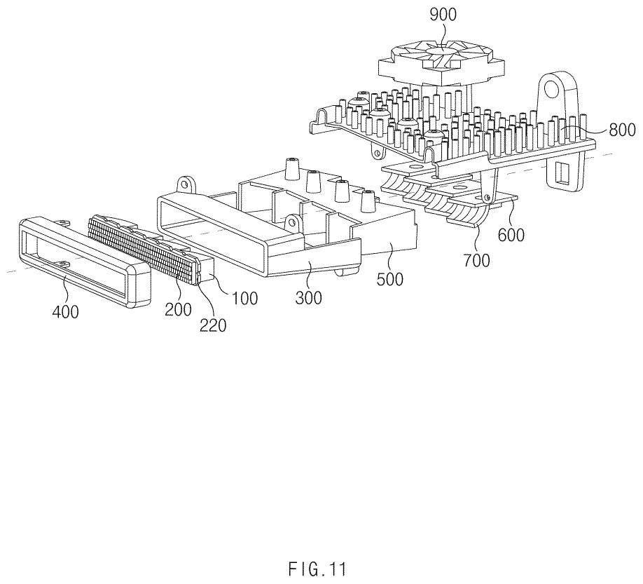

FIG. 1 is a perspective view illustrating a structure of a lamp for a vehicle according to the present disclosure, FIG. 2 is a perspective view illustrating a structure of a light-entering part according to a first embodiment of the lamp for a vehicle according to the present disclosure, FIG. 3 is a top plan view illustrating a structure in which facets formed on an emergent surface and patterns formed on an incident surface of the lamp for a vehicle according to the present disclosure, are disposed, FIG. 4 is a perspective view illustrating a structure of a light-entering part according to a second embodiment of the lamp for a vehicle according to the present disclosure, FIG. 5 is a perspective view illustrating a structure of a light-entering part according to a third embodiment of the lamp for a vehicle according to the present disclosure, FIG. 6 is a perspective view illustrating a structure of a light-entering part according to a fourth embodiment of the lamp for a vehicle according to the present disclosure, FIG. 7 is a perspective view illustrating a structure of a light-entering part according to a fifth embodiment of the lamp for a vehicle according to the present disclosure, FIG. 8 is a perspective view illustrating a structure of a light-entering part according to a sixth embodiment of the lamp for a vehicle according to the present disclosure, FIG. 9 is a perspective view illustrating a structure of a light-entering part according to a seventh embodiment of the lamp for a vehicle according to the present disclosure, FIG. 10 is a perspective view illustrating structures of facets formed on the emergent surface of the lamp for a vehicle according to the present disclosure, and FIG. 11 is an exploded perspective view illustrating a disassembled structure of the lamp for a vehicle according to the present disclosure.

As illustrated in FIG. 1, the lamp for a vehicle according to the present disclosure includes a light-entering part 100 installed relatively forward based on a propagation direction of light emitted from a light source installed in the lamp for a vehicle, the light-entering part 100 being configured to receive the light emitted from the light source and having a plurality of patterns 111 formed on an incident surface 110, and a light-exiting part 200 configured to allow the light having passed through the light-entering part 100 to propagate forward to the outside while passing through the light-exiting part 200, the light-exiting part 200 having a plurality of facets 211 formed on an emergent surface 210.

The light-entering part 100 refers to a member that receives the light emitted from the light source installed in the lamp for a vehicle. The light-entering part 100 is made of a material capable of transmitting light. The plurality of patterns 111 are formed on the incident surface 110 formed on a surface of the light-entering part 100.

The patterns 111 formed on the incident surface 110 may improve the uniformity of the light entering the light-entering part 100 and improve the feeling uniformity of the light exiting through the light-exiting part 200 to be described below.

Three methods are broadly used to form the patterns 111 on the incident surface 110. The first method is a pad printing method that is simple and efficient and may apply patterns onto a three-dimensional surface. The first method transfers and prints the patterns 111 on a desired surface by using a flexible silicone pad. The first method is advantageous in implementing various patterns by using pads with various materials and sizes.

The second method is a laser processing method that provides desired patterns by using a laser. The second method may form microscale and nanoscale patterns on a surface of an optical component by adjusting laser beams. The second method is advantageous in providing high precision and repeatability and being applied to various materials.

The third method is a nano-critical phenomenon method. The third method uses heat and pressure to form nanoscale patterns. The third method is advantageous in forming high-resolution and high-density patterns by performing a process of applying heat and pressure to a surface on which patterns are intended to be formed so that the patterns are formed autonomously.

Further, stepped portions 120 recessed inward in the propagation direction of the light are disposed at a plurality of points on the light-entering part 100 and spaced apart from one another at predetermined intervals in a width direction of the light-entering part 100.

The stepped portions 120 are disposed to be spaced apart from one another at predetermined intervals in the width direction of the light-entering part 100, such that it is possible to provide the feeling that the lamp for a vehicle is divided in a vertical direction when the lamp for a vehicle is viewed from the front side in a state in which power is applied to the light source.

### First Embodiment

As illustrated in FIG. 2, the plurality of patterns 111 formed on the incident surface 110 of the light-entering part 100 according to the first embodiment of the lamp for a vehicle according to the present disclosure may be configured as lattice patterns 111a formed in height direction and a width direction of the light-entering part 100.

In case that the plurality of patterns 111 formed on the incident surface 110 are formed as the lattice patterns 111a, it is effective that the lattice patterns 111a are arranged at intersection positions without overlapping the facets 211 formed on the emergent surface 210 in the propagation direction of the light.

Further, as illustrated in FIG. 3, the plurality of patterns 111 formed on the incident surface 110 are arranged at the intersection positions without overlapping the patterns defined by the facets 211 formed on the emergent surface 210, such that the patterns, which are smaller in size and larger in number than the patterns formed on the incident surface 110, may be implemented to be recognized.

In order to improve the user's satisfaction, the lattice patterns 111a may be formed so that a degree to which the lattice patterns 111a formed on the incident surface 110 intersect the facets 211 formed on the emergent surface 210 is a desired degree, as necessary.

The patterns on the incident surfaces 110 formed on the lamps for a vehicle according to the second to seventh embodiments to be described below differ from the patterns on the incident surface 110 according to the first embodiment of the present disclosure only in terms of shapes. The configuration in which the patterns formed on the incident surface 110 and the patterns defined by the facets 211 may be disposed at the intersection positions without overlapping one another and the intersection degree may be adjusted may be applied in the same way.

### Second Embodiment

As illustrated in FIG. 4, the plurality of patterns 111 formed on the incident surface 110 according to the second embodiment of the lamp for a vehicle according to the present disclosure may be configured as diagonal patterns 111b formed in a diagonal direction of the light-entering part 100.

In case that the patterns formed on the light-entering part 100 are configured as the diagonal patterns 111b, it is effective that the diagonal patterns 111b are disposed to connect vertices of the lattice patterns of the facets 211 in the diagonal direction when the lamp for a vehicle is viewed from the front side.

As described above, in case that the plurality of patterns 111 are configured as the diagonal patterns 111b, the lattice patterns of the facets 211 formed on the emergent surface 210 of the light-exiting part 200 are matched with the diagonal patterns 111b, such that aesthetic appearances may be implemented when the lamp for a vehicle is viewed from the front side in the state in which power is applied to the light source.

### Third Embodiment

Further, as illustrated in FIG. 5, the diagonal patterns 111b formed on the incident surface 110 according to the third embodiment of the lamp for a vehicle according to the present disclosure may be formed to be curved inward.

In case that the diagonal patterns 111b are formed to be curved inward, it is effective that the vertices of the diagonal patterns 111b are positioned at centers of sides of the lattice patterns of the facets 211 when the lamp for a vehicle is viewed from the front side, such that visual clearness may be implemented.

### Fourth Embodiment

As illustrated in FIG. 6, the plurality of patterns 111 formed on the incident surface 110 according to the fourth embodiment of the lamp for a vehicle according to the present disclosure may be formed as circular or elliptical patterns 111c.

In case that the plurality of patterns 111 formed on the incident surface 110 are formed as the circular or elliptical patterns 111c, it is effective that the centers of the circular or elliptical patterns 111c overlap the vertices of the lattice patterns defined by the facets 211 when the lamp for a vehicle is viewed from the front side, such that visual clearness may be implemented.

### Fifth Embodiment

As illustrated in FIG. 7, the plurality of patterns 111 formed on the incident surface 110 according to the fifth embodiment of the lamp for a vehicle according to the present disclosure may be formed as triangular patterns 111d.

In case that the plurality of patterns 111 formed on the incident surface 110 are formed as the triangular patterns 111d, it is effective that the centers of the triangular patterns 111d overlap the vertices of the lattice patterns defined by the facets 211 when the lamp for a vehicle is viewed from the front side, such that visual clearness may be implemented.

### Sixth Embodiment

As illustrated in FIG. 8, the plurality of patterns 111 formed on the incident surface 110 according to the sixth embodiment of the lamp for a vehicle according to the present disclosure may be formed as hexagonal patterns 111e.

In case that the plurality of patterns 111 formed on the incident surface 110 are formed as the hexagonal patterns 111e, it is effective that the centers of the hexagonal patterns 111e overlap the vertices of the lattice patterns defined by the facets 221 when the lamp for a vehicle is viewed from the front side, such that visual clearness may be implemented.

### Seventh Embodiment

As illustrated in FIG. 9, the plurality of patterns 111 formed on the incident surface 110 according to the seventh embodiment of the lamp for a vehicle according to the present disclosure may be formed as octagonal patterns 111f.

In case that the plurality of patterns 111 formed on the incident surface 110 are formed as the octagonal patterns 111f, it is effective that the centers of the octagonal patterns 111f overlap the vertices of the lattice patterns defined by the facets 211 when the lamp for a vehicle is viewed from the front side, such that visual clearness may be implemented.

Further, a plate surface of the incident surface 110, on which the patterns 111 according to the first to seventh embodiments of the lamp for a vehicle according to the present disclosure are formed, is formed to be curved, such that the light propagates forward in the state in which the light emitted from the light source is collected to a certain extent after passing through the light-entering part 100, thereby improving the uniformity of light.

The light-exiting part 200 allows the light having passed through the light-entering part 100 to propagate forward to the outside while passing through the light-exiting part 200. The plurality of facets 211 are formed on the emergent surface 210. The facets 211 define the lattice patterns on the emergent surface 210 of the light-exiting part 200. A front surface of the facet 211 protrudes forward.

Further, as illustrated in FIG. 10, a light transmittance-reducing member for reducing light transmittance may be installed in an edge region of at least a part of the facet 211 provided on the emergent surface 210 of the light-exiting part 200. The light transmittance-reducing member may include edge portion pads 211a printed in the edge region of at least a part of the facet 211.

The edge portion pad 211a is printed in the edge region of at least a part of the facet 211, such that glare may be efficiently and precisely reduced. The edge portion pad 211a, which has light transmittance desired by the user, may be selected by the user and printed so that the light transmittance of the edge portion pad 211a is defined.

Further, in the case of the lamp for a vehicle according to the present disclosure, the edge portion pad 211a having light transmittance of 40 to 60% may be printed to reduce glare. As described above, the light transmittance of the edge portion pad 211a may be selectively changed, as necessary.

In addition, the lamp for a vehicle configured as described above may further include a connection member 220 disposed between the light-entering part 100 and the light-exiting part 200 so that the light-entering part 100 and the light-exiting part 200 are connected to each other by being fixed to plate surfaces of the connection member 220 disposed in opposite directions.

A width and a height of the connection member 220 are relatively larger than a width and a height of the light-entering part 100 and a width and a height of the light-exiting part 200, such that a peripheral surface of the connection member 220 protrudes outward from the light-entering part 100 and the light-exiting part 200 in the direction of the plate surface.

The width and the height of the connection member 220 are relatively larger than the width and the height of the light-entering part 100 and the width and the height of the light-exiting part 200, and the connection member 220 protrudes, such that the connection member 220 is seated on a lens holder 300 to be described below during the process of assembling the lamp for a vehicle according to the present disclosure, such that a lens may be quickly and accurately assembled.

Meanwhile, as illustrated in FIG. 11, a vehicle having the lamp for a vehicle according to the present disclosure includes the lamp for a vehicle having the light-entering part 100 and the light-exiting part 200, the lens holder 300 to which the lamp for a vehicle is assembled, a lens cover 400 assembled to the lens holder 300 to maintain a state in which the lamp for a vehicle is assembled to the lens holder 300, a sidewall 500 to which the lens holder 300 to which the lens cover 400 is assembled is coupled, a PCB 600 disposed in the sidewall 500 and provided with the light source, a reflector 700 installed at one side of the PCB 600 and configured to reflect the light emitted from the light source, a heat sink 800 connected to one side of the PCB 600 and configured to quickly dissipate heat generated from the PCB 600, and a cooling fan 900 disposed at one side of the heat sink 800 and configured to cool the heat sink 800.

Further, a periphery of the connection member 220 being relatively larger in length, width, and height than the light-entering part 100 and the light-exiting part 200 and thus protruding outward is seated on the lens holder 300 in the direction of the plate surface, such that the lamp for a vehicle may be easily, accurately, and effectively assembled.

According to the lamp for a vehicle according to the present disclosure configured as described above, the plurality of patterns may be formed on the incident surface of the light-entering part formed on the lens installed in the lamp for a vehicle to improve the uniformity of light emitted through the light-exiting part, and the light transmittance of light emitted from the edge of the emergent surface formed on the light-exiting part may be adjusted to efficiently and precisely reduce glare.

While the embodiments, which may be implemented by the present disclosure, have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. A lamp for a vehicle, comprising:
a light-entering part positioned to receive a light propagated from a light source of the lamp, the light-entering part including an incident surface having a plurality of patterns; and
a light-exiting part including an emergent surface having a plurality of facets, wherein the light emitted from the light source passes through the light-entering part and then propagates externally through the light-exiting part.

2. The lamp of claim 1, wherein the plurality of patterns of the incident surface of the light-entering part includes a plurality of lattice patterns arranged in a height direction and a width direction of the light-entering part.

3. The lamp of claim 2, wherein the plurality of lattice patterns is arranged at a plurality of intersection positions without overlapping a plurality of patterns of the plurality of facets of the emergent surface of the light-exiting part in a propagation direction of the light.

4. The lamp of claim 1, wherein the plurality of patterns of the incident surface of the light-entering part includes a plurality of diagonal patterns arranged in a diagonal direction of the light-entering part.

5. The lamp of claim 4, wherein the plurality of diagonal patterns is curved inwardly.

6. The lamp of claim 1, wherein the plurality of patterns of the incident surface of the light-entering part includes a plurality of circular or elliptical patterns.

7. The lamp of claim 1, wherein the plurality of patterns of the incident surface of the light-entering part includes a plurality of triangular patterns.

8. The lamp of claim 1, wherein the plurality of patterns of the incident surface of the light-entering part includes a plurality of hexagonal patterns.

9. The lamp of claim 1, wherein the plurality of patterns of the incident surface of the light-entering part includes a plurality of octagonal patterns.

10. The lamp of claim 1, wherein the incident surface of the light-entering part includes a curved plate surface.

11. The lamp of claim 1, wherein the light-entering part includes a plurality of stepped portions recessed inward in a propagation direction of the light and spaced apart from each other in a width direction of the light-entering part.

12. The lamp of claim 1, wherein the light-exiting part comprises a light transmittance-reducing member disposed at an edge region of a part of at least some of the plurality of facets of the emergent surface of the light-exiting part and configured to reduce light transmittance.

13. The lamp of claim 12, wherein the light transmittance-reducing member comprises an edge portion pad printed in the edge region of the part of at least some of the plurality of facets of the emergent surface of the light-exiting part.

14. The lamp of claim 1, further comprising a connection member disposed between the light-entering part and the light-exiting part and having first and second plate surfaces facing in opposite directions and respectively connected to the light-entering part and the light-exiting part.

15. The lamp of claim 14, wherein:
the connection member has a periphery protruding outwardly, the periphery of the connection member being larger than that of the light-entering part and the light-exiting part, and
the lamp further comprises a lens holder on which the periphery of the connection member is seated.
